(19) United States
(12) Patent Application Publication
(10) Pub. No.: US 2020/0363536 A1
(43) Pub. Date: Nov. 19, 2020

(54) METHODS FOR ENHANCING NON-GLOBAL NAVIGATION SATELLITE SYSTEM LOCATION AND TIMING PSEUDORANGE POSITIONING CALCULATIONS AND SYSTEMS THEREOF

(71) Applicant: Orolia USA Inc., W. Henrietta, NY (US)

(72) Inventors: Oleg Garitselov, Rochester, NY (US); John Fischer, Corfu, NY (US)

(21) Appl. No.: 16/414,430

(22) Filed: May 16, 2019

(51) Int. Cl. G01S 19/41; G01S 19/42; G01S 19/07; G01S 19/33

(52) U.S. Cl. CPC G01S 19/41; G01S 19/33; G01S 19/07; G01S 19/423

(57) ABSTRACT

A method, non-transitory computer readable medium, and system that determines for received data from one of a plurality of non-Global Navigation Satellite Systems (non-GNSS) satellites a correction for an error in captured time associated with the one of the non-GNSS satellites. A distance error is calculated based on the determined correction. A calculated pseudorange measurement for the received data from the one of a plurality of non-GNSS satellites is adjusted based on the obtained distance error.

### FIELD

This technology generally relates to methods and systems that provide autonomous geo-spatial positioning and, more particularly, to methods for enhancing non-Global Navigation Satellite System (GNSS) location and timing pseudorange positioning calculations and devices thereof.

### BACKGROUND

In a navigation and communications environment 10 as illustrated in FIG. 1, non-GNSS satellites, such as Low Earth Orbit (LEO) satellites 14(1)-14(n), typically used for communications, are now being re-purposed for providing Satellite Timing Location (STL). LEO signals from the LEO satellites 14(1)-14(n) are much stronger than Global Navigation Satellite System (GNSS) signals from Global Navigation Satellite Systems (GNSS) or Mid Earth Orbits (MEO) satellites 12(1)-12(n) because of their closer proximity to earth—GNSS satellites 12(1)-12(n) reside in MEO, ˜20,000 km higher that LEO. By measuring the time delay and frequency Doppler shifts of packets transmitted from the LEO satellites 14(1)-14(n) to the earth, range and range rate measurements are made to determine a position. These measurements can be used to augment the position and timing determined via Global Navigation Satellite Systems (GNSS) systems.

However, since these LEO satellites 14(1)-14(n) were designed for communications instead of navigation, typically the on-board clocks in LEO satellites are much less accurate, contributing to large position errors. Additionally, typically very cheap oscillators are utilized in the ground receiver utilized for determining positioning, so the calculated time delay for data packet transmission often is not very accurate.

### SUMMARY

An example of a method enhancing a pseudorange positioning calculation includes determining, by a computing device, for received data from one of a plurality of non-Global Navigation Satellite Systems (non-GNSS) satellites a correction for an error in captured time associated with the one of the non-GNSS satellites. A distance error is calculated, by the computing device, based on the determined correction. A calculated pseudorange measurement for the received data from the one of a plurality of non-GNSS satellites is adjusted, by the computing device, based on the obtained distance error.

An example of a non-GNSS system includes a navigation computing device with a memory comprising programmed instructions stored thereon and one or more processors configured to be capable of executing the stored programmed instructions to determine for received data from one of a plurality of non-Global Navigation Satellite Systems (non-GNSS) satellites a correction for an error in captured time associated with the one of the non-GNSS satellites. A distance error is calculated based on the determined correction. A calculated pseudorange measurement for the received data from the one of a plurality of non-GNSS satellites is adjusted based on the obtained distance error.

A non-transitory machine readable medium having stored thereon instructions comprising executable code which when executed by one or more processors, causes the processors to determine for received data from one of a plurality of non-Global Navigation Satellite Systems (non-GNSS) satellites a correction for an error in captured time associated with the one of the non-GNSS satellites. A distance error is calculated based on the determined correction. A calculated pseudorange measurement for the received data from the one of a plurality of non-GNSS satellites is adjusted based on the obtained distance error.

This technology provides a number of advantages including providing methods, non-transitory computer readable media, and systems that enhance non-GNSS location and timing pseudorange positioning calculations. With examples of this technology, a continuously available precise time is obtained from sources, such as a GNSS Disciplined Oscillator (GNSSDO) associated with a GNSS satellite. This precise time is used to compensate for an inaccuracy with a captured time associated with a non-GNSS satellite to enable non-GNSS range and range rate measurements to be used for determining accurate positioning for periods of time, such as when GNSS is unavailable.

### BRIEF DESCRIPTION OF THE DRAWINGS

FIG. 1 is block diagram of an example of a navigation and communications environment with GNSS or MEO satellites and LEO satellites;

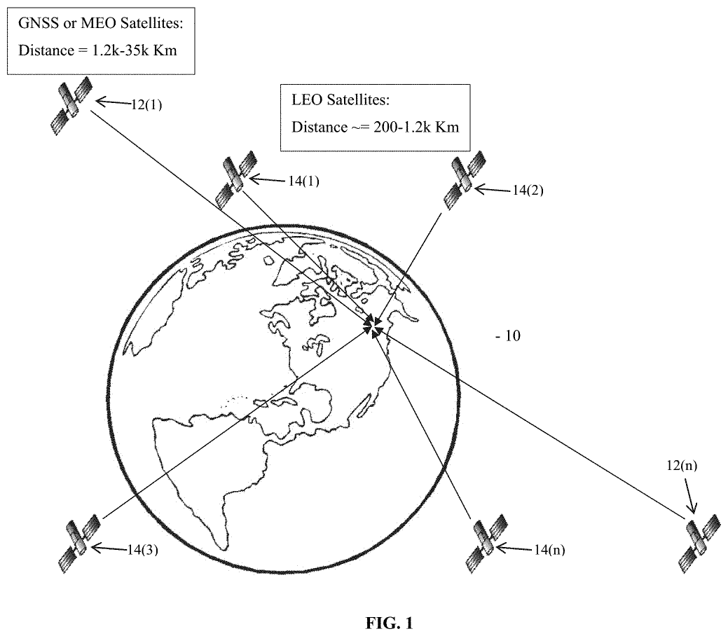

FIG. 2 is a block diagram of an example of a LEO navigation system with a navigation computing device and a LEO receiver device with a LEO oscillator and a GNSS receiver device with a GNSS disciplined oscillator; and

FIG. 3 is a flow chart of an example of a method for enhancing LEO location and timing pseudorange positioning calculations.

### DETAILED DESCRIPTION

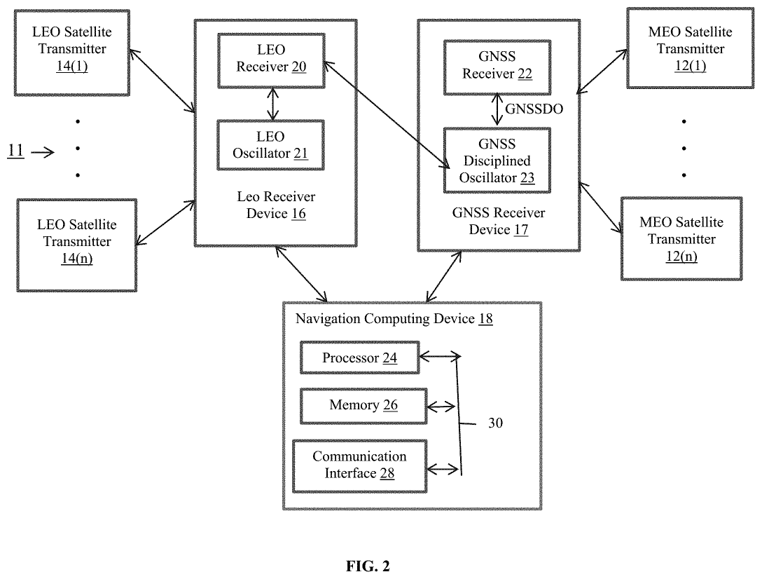

An example of a LEO navigation system 11 that enhances LEO location and timing pseudorange positioning calculations is illustrated in FIG. 2. In this example, the LEO navigation system 11 includes a LEO receiver device 16, a GNSS receiver device 17, and navigation computing device 18, although other types of non-GNSS navigation systems with other types and/or numbers of other systems, devices, components, and/or other elements in other configurations may be used. This technology provides a number of advantages including providing methods and systems that enhance non-GNSS location and timing pseudorange positioning calculations.

Referring more specifically to FIG. 2, in this example the LEO receiver device 16 comprises a LEO receiver 20 coupled to a LEO oscillator 21, although the other types of non-GNSS receiver devices with other types and/or numbers of other systems, devices, components, and/or other elements in other configurations may be used. Additionally, in this example, the LEO receiver device 16 is coupled to a GNSS disciplined oscillator 23, which in this example is in the GNSS Receiver Device 17, although the GNSS disciplined oscillator 23 may be in other locations. Further, in this example the LEO receiver 20 is configured to receive signals, such as data packets transmitted by one or more of the LEO Satellite Transmitters 14(1)-14(n), and may otherwise be configured to interact and/or communicate with other receiver devices, such as the GNSS receiver device 17, although other configurations may be used. Additionally, in this example the LEO oscillator 21 is an oscillator with less than about 10¹⁰ stability, although other types of oscillators or timing elements that are less accurate than a GNSS disciplined oscillator also may be used. Although one LEO receiver device 16 is shown, other numbers and/or types of LEO and/or other non-GNSS receiver devices may be used.

The GNSS receiver device 17 comprises a GNSS receiver 22 coupled to a GNSS disciplined oscillator 23, although the GNSS receiver device may comprise other types and/or numbers of other systems, devices, components, and/or other elements in other configurations. The GNSS receiver 22 is configured to capture signals, such as data packets, from MEO satellites 12(1)-12(n) when navigation or other positioning is to be determined, although other types of receivers may be used. In this example, the GNSS disciplined oscillator 23 is an oscillator whose output is controlled to agree with the signals broadcast by GNSS satellites 12(1)-12(n), although other types of controlled or disciplined oscillators or other timing elements with similar accuracy may be used. In this example, the GNSS disciplined oscillator 23 is an oscillator with at least about 10⁻⁶ stability to provide in these examples the necessary accuracy for the calculated measurements, although other stability ranges may be used. By way of example only, the GNSS disciplined oscillator 23 may be a TCXO—Temperature Compensated quartz crystal Oscillator with at least about 10⁻⁶ stability, an OCXO—Oven Controlled quartz crystal Oscillator with about a 10⁻⁸-10⁻¹⁰ stability, or an Atomic Oscillator with about a 10⁻¹¹-10⁻¹² stability. Further, in this example, the GNSS disciplined oscillator 23 is coupled to the LEO receiver device 16.

The navigation computing device 18 in this example includes at least one processor 24, a memory 26, and/or a communication interface 28, which are coupled together by a bus or other communication link 30, although the navigation computing device 18 can include other types and/or numbers of elements in other configurations. Additionally, in this example one navigation computing device 18 is illustrated, although other configurations may be used, such as one where a separate control unit device which may be either integrated in with or separate from the LEO receiver device 16 or other non-GNSS receiver device. Further, in this example the navigation computing device 18 may be used to determine the necessary correction to the range and range rate measurement from one or more of the LEO satellites 14(1)-14(n) or other non-GNSS satellites and which is coupled to the navigation computing device 18 and to determine navigation or other positioning by way of example only.

The navigation computing device 18 in this example also may determine or otherwise obtain data to assist with determining navigation or other positioning, such as data on the true range (φ, satellite orbital errors (d_{ρ}), ionospheric delay (dᵢₒₙ), tropospheric delay (dₜᵣₒₚ), multipath noise (εₘₚ), and/or receiver noise (εₚ), although other types and/or amounts of other data may be determined or otherwise obtained to assist with determining navigation or other positioning. Additionally, in other examples the navigation computing device 18 may comprise executable programmed instructions for determining or otherwise obtaining and using this data for measurements and position calculations.

The processor 24 of the navigation computing device 18 may execute programmed instructions stored in the memory for the any number of the functions or other operations illustrated and described by way of the examples herein. The processor 24 of the navigation computing device 18 may include one or more CPUs or general purpose processors with one or more processing cores, for example, although other types of processor(s) can also be used.

The memory 26 of the navigation computing device 18 stores these programmed instructions for one or more aspects of the present technology as illustrated and described herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 26.

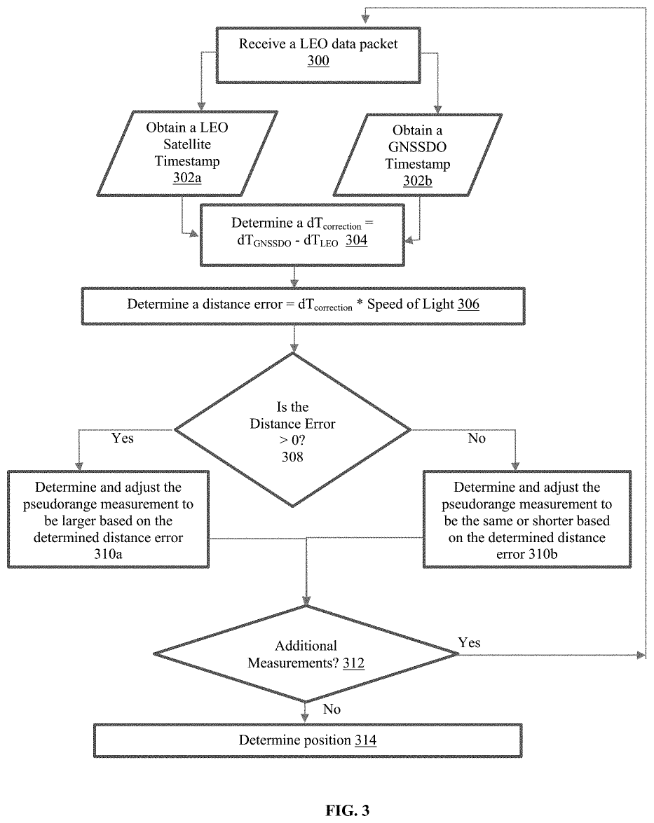

Accordingly, the memory 26 of the navigation computing device 18 can store application(s) that can include executable instructions that, when executed by the navigation computing device 18, cause the navigation computing device 18 to perform actions, such as to transmit, receive, or otherwise process signals from LEO satellites 14(1)-14(n) or other non-GNSS satellites for providing navigation or other positioning, for example, and to perform other actions illustrated and described by way of the examples herein with reference to FIGS. 2-3. The application(s) can be implemented as modules or components of other application(s). Further, the application(s) can be implemented as operating system extensions, module, plugins, or the like.

The communication interface 28 of the navigation computing device 18 operatively couples and communicates between the navigation computing device 18 and the LEO receiver device 16 and the GNSS receiver device 17 which are all coupled together by one or more communication network(s), although other types and/or numbers of connections and/or configurations to other devices and/or elements can be used. By way of example only, the communication network(s) can include local area network(s) (LAN(s)) or wide area network(s) (WAN(s)), and/or wireless networks by way of example only, although other types and/or numbers of protocols and/or communication networks can be used.

Although a LEO navigation system 11 with the LEO receiver device 16, the GNSS receiver device 17, and the navigation computing device 18 are illustrated and described herein, the navigation system 11 may comprise other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

Portions of all of the examples of the technology illustrated and described herein may also be embodied as one or more non-transitory computer readable media having instructions stored thereon for one or more aspects of the present technology. The instructions in some examples include executable code that, when executed by the processor 24 of the navigation computing device 18, cause the processor to carry out steps necessary to implement the methods of the examples of this technology that are illustrated and described herein.

An exemplary method for enhancing location and timing pseudorange positioning calculations will now be described with reference to FIGS. 2-3. Referring more specifically to FIG. 3, in step 300, when the navigation computing device 18 determines that navigation or other positioning via the GNSS receiver device 17 and one or more of the GNSS or MEO satellites 12(1)-12(n) is, for example, unavailable, then the navigation computing device 18 may interact with the LEO receiver device 16 and one or more of the LEO satellites 14(1)-14(n), although this determination may be based on other factors and with other non-GNSS satellites and receivers or other systems. In this example, the navigation computing device 18 may engage with the LEO receiver device 16 to monitor with the LEO receiver 20 for a signal, such as a data packet, from one of the LEO satellites 14(1)-14(n).

In step 302a, when the LEO receiver 20 captures a signal, such as a data packet, from one of the LEO satellites 14(1)-14(n), then the LEO receiver device 16 obtains a LEO satellite timestamp, e.g. dT_{LEO}, with the LEO oscillator 21 for the received data packet from the one of the LEO satellites 14(1)-14(n) which is transmitted to and received by the navigation computing device 18. In this example, the LEO satellite timestamp is inaccurate because of accuracy issues with the LEO oscillator 21, although other elements may also introduce in accuracies. Additionally, in step 302b the navigation computing device 18 also receives a GNSSDO timestamp, e.g. dT_{GNSSDO}, with the GNSS disciplined oscillator 23 in the GNSS receiver device 17, in this example, at the time the data packet from the one of the LEO satellites 14(1)-14(n) is received. In this example, the GNSSDO timestamp is more accurate that the LEO satellite timestamp and may be used for determining a correction as discussed in the example below.

In step 304, the navigation computing device 18 determines a timing correction, i.e. dT_{correction}, by calculating a difference between the LEO satellite timestamp, i.e. dT_{LEO}, and the GNSSDO timestamp, e.g. dT_{GNSSDO}, which can be used to substantially enhance the accuracy of the determined pseudorange measurement as later described in greater detail below, although other manners for obtaining the timing correction could be used. In this example, the navigation computing device 18 may calculate the a timing correction, i.e. dT_{correction}, on each one pulse per second (1PPS) cycle, although other timing may be used.

This timing correction, i.e. dT_{correction}, is needed because the receiver clock offset from the LEO satellite timestamp obtained from the LEO oscillator 21, i.e. dT, is in this example a major contributor to errors in pseudorange measurements. By way of example only, a three (3) nanosecond (ns) timing error can contribute to a roughly one (1) meter error in accuracy in pseudorange measurements. In some other exemplary cases of LEO receiver devices with very low quality oscillators, the error may be on the order of microseconds resulting in even larger errors. Instead, with examples of the claimed technology, the GNSSDO timestamp obtained from the GNSS disciplined oscillator 23 in the GNSS receiver device 17 is utilized to make the pseudorange measurements more accurate, since GNSSDO time is much more accurate. As illustrated and described by way of the examples herein, by using a high precision oscillator or other timing element, such as the GNSS disciplined oscillator 23 in the GNSS receiver device 17, to make the necessary correction, examples of this technology can achieve accuracies closer to nanosecond accuracies obtained from the GNSS atomic satellite clocks.

Accordingly, when determining the pseudorange measurement as again discussed with examples in greater detail below, the navigation computing device 18 adjusts the receiver clock offset from time obtained from the LEO oscillator 21, i.e. dT, to be a new receiver clock offset from GNSS time, i.e. dT_{new}, which comprises a sum of the dT and this dT_{correction}, where dT_{correction} is again the difference between the GNSSDO time and LEO satellite time.

In step 306, the navigation computing device 18 determines a distance error based on the difference between the GNSSDO time and LEO satellite time, i.e. dT_{correction}, multiplied by the speed of light (c), although other manners for determining a distance error may be used.

In step 308, the navigation computing device 18 determines when the determined distance error is greater than zero. If in step 308, the navigation computing device 18 determines the determined distance error is greater than zero, than the Yes branch is taken to step 310a.

In step 310a, the pseudorange measurement may be calculated by the navigation computing device 18 executing, by way of example only, programmed instructions, for the following equation:

p=ρ+dρ+c(dt−(dT+dT_{correction}))+dion+dtrop+εmp+εp

where:
p=the pseudorange measurement
ρ=the true range
dρ=satellite orbital errors
c=the speed of light
dt=satellite clock offset from GNSS time
dT=receiver clock offset from GNSS time
dion=ionospheric delay
dtrop=tropospheric delay
εmp=multipath noise
εp=receiver noise

In this example, to calculate this pseudorange measurement the navigation computing device 18 may obtain or otherwise determine data, such as data on the true range (ρ), satellite orbital errors (d_{ρ}), ionospheric delay (dᵢₒₙ), tropospheric delay (dₜᵣₒₚ), multipath noise (εmp), and/or receiver noise (εp), although in other examples other manners for obtaining or determining some or all of the data needed for calculating this pseudorange measurement can be used. Additionally, since the navigation computing device 18 determines the distance error is greater than zero, then the navigation computing device 18 corrects the pseudorange measurement by adding the determined distance error which in this case will make the pseudorange measurement larger.

If back in step 308, the navigation computing device 18, the navigation computing device 18 determines the distance error is not greater than zero, than the No branch is taken to step 310b. In step 310b, the pseudorange measurement may be calculated by the navigation computing device 18 in the same manner as illustrated and described above in step 310a. Additionally, since the navigation computing device 18 determines the distance error is not greater than zero, then the navigation computing device 18 corrects the pseudorange measurement by subtracting the determined distance error which in this case will make the pseudorange measurement smaller or will make no change if the determined distance error is zero.

In step 312, the navigation computing device 18 determines when additional pseudorange measurements are needed to determine navigation or other positioning. If in step 312, the navigation computing device 18 determines an additional pseudorange measurement is needed, then the Yes branch may be taken back to step 300 to process another data packet or other signal as illustrated and described above.

If in step 312, the navigation computing device 18 determines an additional pseudorange measurement is not needed, then the No branch may be taken to step 314. In step 314, the navigation computing device 18 may use the pseudorange measurements from four of the LEO satellites 14(1)-14(n) to determining a current position, although other manners for determining positioning or navigation may be used.

In another example, the structure and operation is the same as illustrated and described herein, except in this alternative example there is a control unit (not shown) that may be responsible for calculating the real time offset between the GNSSDO and LEO Receiver. This control unit may also provide real-time calculations for dT_{correction}, as well as adjusted pseudorange measurements which may be provided to the navigation computing device 18 to use these adjusted metrics to calculate the current location for each satellite signal.

Accordingly, as illustrated and described by way of the examples here, this technology provides methods and systems that enhance non-GNSS location and timing pseudorange positioning calculations. With examples of this technology, a continuously available precise time is obtained from sources, such as a GNSS Disciplined Oscillator (GNSSDO) associated with a GNSS satellite. This precise time is used to compensate for an inaccuracy with a captured time associated with a non-GNSS satellite to enable non-GNSS range and range rate measurements to be used for determining accurate positioning for periods of time, such as when GNSS is unavailable.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for enhancing a pseudorange positioning calculation, the method comprising:
determining, by a computing device, for received data from one of a plurality of non-Global Navigation Satellite Systems (non-GNSS) satellites a correction for an error in captured time associated with the one of the non-GNSS satellites;
calculating, by the computing device, a distance error based on the determined correction; and
adjusting, by the computing device, a calculated pseudorange measurement for the received data from the one of a plurality of non-GNSS satellites based on the obtained distance error.

2. The method of claim 1 further comprising:
obtaining, by the computing device, a plurality of adjusted calculated pseudorange measurements from other non-GNSS satellites; and
determining, by the computing device, a current position based on the plurality of the adjusted calculated pseudorange measurements.

3. The method of claim 1 wherein the determining the correction for the error in captured time further comprises:
determining, by the computing device, the correction for the error in captured time based on a difference between an obtained non-GNSS timestamp from the one of the non-GNSS satellites and a Global Navigation Satellite Systems Disciplined Oscillator (GNSSDO) timestamp obtained from a GNSS satellite.

4. The method of claim 1 wherein the calculating the distance error based on the determined correction further comprises:
calculating, by the computing device, the distance error based on the determined correction multiplied by the speed of light.

5. The method of claim 1 wherein the one of the non-GNSS satellites is a low earth orbit (LEO) satellite.

6. The method of claim 5 wherein the GNSSDO timestamp is obtained from an oscillator with at least a 10⁻⁶ stability.

7. The method of claim 6 wherein the oscillator comprises at least one of a Temperature Compensated quartz crystal Oscillator with at least about 10⁻⁶ stability, an Oven Controlled quartz crystal Oscillator with about a 10⁻⁸-10⁻¹⁰ stability, or an Atomic Oscillator with about a 10⁻¹¹-10⁻¹² stability.

8. A non-transitory machine readable medium having stored thereon instructions comprising executable code which when executed by one or more processors, causes the processors to:
determine for received data from one of a plurality of non-Global Navigation Satellite Systems (non-GNSS) satellites a correction for an error in captured time associated with the one of the non-GNSS satellites;
calculate a distance error based on the determined correction; and
adjust a calculated pseudorange measurement for the received data from the one of a plurality of non-GNSS satellites based on the obtained distance error.

9. The non-transitory machine readable medium of claim 8, wherein the executable code, when executed by the processors, further causes the processors to:
obtain a plurality of adjusted calculated pseudorange measurements from other non-GNSS satellites; and
determine a current position based on the plurality of the adjusted calculated pseudorange measurements.

10. The non-transitory machine readable medium of claim 8, wherein for the determine the correction for the error in captured time, the executable code, when executed by the processors, further causes the processors to:
determine the correction for the error in captured time based on a difference between an obtained non-GNSS timestamp from the one of the non-GNSS satellites and a Global Navigation Satellite Systems Disciplined Oscillator (GNSSDO) timestamp obtained from a GNSS satellite.

11. The non-transitory machine readable medium of claim 8, wherein for the calculate the distance error based on the determined correction, the executable code, when executed by the processors, further causes the processors to:
calculate the distance error based on the determined correction multiplied by the speed of light.

12. The non-transitory machine readable medium of claim 8 wherein the one of the non-GNSS satellites is a low earth orbit (LEO) satellite.

13. The non-transitory machine readable medium of claim 12 wherein the GNSSDO timestamp is obtained from an oscillator with at least a 10⁻⁶ stability

14. The non-transitory machine readable medium of claim 13 wherein the oscillator comprises at least one of a Temperature Compensated quartz crystal Oscillator with at least about 10⁻⁶ stability, an Oven Controlled quartz crystal Oscillator with about a 10⁻⁸-10⁻¹⁰ stability, or an Atomic Oscillator with about a 10⁻¹¹-10⁻¹² stability.

15. A navigation system comprising:
a navigation computing device with a memory comprising programmed instructions stored thereon and one or more processors configured to be capable of executing the stored programmed instructions to:
determine for received data from one of a plurality of non-Global Navigation Satellite Systems (non-GNSS) satellites a correction for an error in captured time associated with the one of the non-GNSS satellites;
calculate a distance error based on the determined correction; and
adjust a calculated pseudorange measurement for the received data from the one of a plurality of non-GNSS satellites based on the obtained distance error.

16. The system of claim 15 wherein the processors are further configured to be capable of executing the stored programmed instructions to:
obtain a plurality of adjusted calculated pseudorange measurements from other non-GNSS satellites; and
determine a current position based on the plurality of the adjusted calculated pseudorange measurements.

17. The system of claim 15 wherein for the determine the correction for the error in captured time, the processors are further configured to be capable of executing the stored programmed instructions to:
determine the correction for the error in captured time based on a difference between an obtained non-GNSS timestamp from the one of the non-GNSS satellites and a Global Navigation Satellite Systems Disciplined Oscillator (GNSSDO) timestamp obtained from a GNSS satellite.

18. The system of claim 15 wherein for the calculate the distance error based on the determined correction, the processors are further configured to be capable of executing the stored programmed instructions to:
calculate the distance error based on the determined correction multiplied by the speed of light.

19. The system of claim 15 wherein the one of the non-GNSS satellites is a low earth orbit (LEO) satellite.

20. The system of claim 19 wherein the GNSSDO timestamp is obtained from an oscillator with at least a 10⁻⁶ stability

21. The system of claim 20 wherein the oscillator comprises at least one of a Temperature Compensated quartz crystal Oscillator with at least about 10⁻⁶ stability, an Oven Controlled quartz crystal Oscillator with about a 10⁻⁸-10⁻¹⁰ stability, or an Atomic Oscillator with about a 10⁻¹¹-10⁻¹² stability.
